(19) United States
(12) Patent Application Publication
(10) Pub. No.: US 2025/0111379 A1
(43) Pub. Date: Apr. 3, 2025

(54) Platform System and Related Methods for Tracking and Notifying Service Providers of Lead Communications

(71) Applicants: CODY MICHAEL DRUMMOND, MORGAN HILL, CA (US); PIERCE BRENNAN DRUMMOND, SAN JOSE, CA (US)

(72) Inventors: CODY MICHAEL DRUMMOND, MORGAN HILL, CA (US); PIERCE BRENNAN DRUMMOND, SAN JOSE, CA (US)

(21) Appl. No.: 18/374,684

(22) Filed: Sep. 29, 2023

(51) Int. Cl. G06Q 30/015

(52) U.S. Cl. CPC G06Q 30/015

(57) ABSTRACT

The disclosed invention relates to a lead management platform designed to enhance the interaction between service providers and leads (potential clients). The system enables service providers to manage and review leads, track instances of bid shopping, receive notifications, and customize preferences. Service providers can also integrate their contact submission forms, select specific industry services, and create comprehensive profiles. The platform facilitates both single and bulk lead imports and offers specific customization regarding notification preferences, providing an effective, user-centric, and streamlined method of lead management and engagement.

### FIELD OF INVENTION

The present invention relates generally to a system for tracking communications. More specifically, the present invention relates to a system for determining that a lead has contacted multiple service providers.

### BACKGROUND

The process of confirming a contract with a lead, i.e. a potential client, is one of the biggest pain points in many service providers' business dealings. Businesses are often flooded with inquiries from individuals who proclaim to wish to secure their services, but who have also contacted many other businesses offering the same or similar services, making the chances of actually securing the work relatively slim. Conversations about beginning a project can be a significant drain on time and resources for businesses, and yet constantly fall through towards the end of negotiations, due to the lead choosing a different service provider.

One of the fundamental issues causing this pain point is that the service provider has no insight whatsoever into how many other businesses the lead is in communication with, and so cannot adjust the level of resources they invest in discussing initial terms with the lead appropriately. For the sake of their own business, the service providers must always assume the lead provides a genuine business opportunity and treat them as such.

If it were possible for a service provider to be notified whenever the lead they are discussing terms with contacted another business providing the same services, and to be made aware of the number of such business that lead had contacted, the service provider would then have the freedom to decide to dedicate minimal resources to discussing terms with leads who have contacted higher numbers of similar service providers.

However, most businesses acquire a large amount of their leads through their own business' web page contact forms, which are variable in formatting and in the information which is gathered for potential clients. Thus, even were competing service providers to collaborate, it would be difficult to determine and track how many of them had been contacted by the same potential client. It is within this context that the present invention is provided.

### SUMMARY

The present invention relates to a system and methods for tracking and managing interactions with leads, or potential clients, by service providers within a specialized platform. The platform addresses the common challenge faced by businesses, where potential clients engage multiple service providers simultaneously, thus diminishing the chance of successfully securing work and leading to wasted resources. Through the platform, users (service providers) can register and upload their company information, specific services they provide, and integrate their websites.

The platform creates a private database of lead profiles and allows users to add leads manually or automatically via website integration. This information includes leads' contact details such as name, address, phone number, and email address. The system employs a matching algorithm that recognizes leads based on minimum requirements like phone number or email. If there's uncertainty, the platform user can confirm if the lead matches existing profiles or create new ones. The matching process includes a confidence rating, accounting for other factors like IP address and browser fingerprint of the lead.

Leads within the system are associated with unique lead IDs, personal information, and associations, including the service providers they've contacted. When a new lead contact event occurs, the servers perform matching, update the lead profile, and notify connected platform users based on their selected preferences. These notifications can be customized to alert service providers when leads contact other businesses offering similar services.

An essential aspect of the system is that detailed lead information (such as reviews and activity records) only becomes accessible to a platform user who has manually input or integrated the required lead details. Ratings and reviews, ranging from 1-5 stars, can also be added after interactions with leads, but these reviews are only visible to users who have confirmed interaction with the lead. This system provides valuable insights to service providers, allowing them to gauge the potential success of a lead and allocate resources more efficiently. By providing a holistic view of a lead's engagement across various providers, the invention empowers service providers to make more informed decisions, enhancing efficiency, and reducing the common problem of lost opportunities.

Service providers register with the platform, verify their business details, and can integrate their website's contact forms with the platform. This automated integration ensures that leads contacting via integrated forms are directly captured and processed within the platform, circumventing manual data entry, and minimizing human-induced errors.

Platform users specify the nature of their services from a predefined list during profile creation. This categorization enhances the notification mechanism, ensuring that service providers are alerted only when leads engage with competitors offering analogous services. Such a selective notification system enables businesses to judiciously allocate resources and prioritize leads based on informed insights.

In some embodiments, the system boasts a sophisticated matching algorithm. When new lead data is introduced, either manually or through website integration, this algorithm evaluates if the data corresponds to an existing lead profile or if a new profile creation is warranted. Predominantly relying on the lead's phone number or email for matching, the system also incorporates auxiliary data such as IP addresses and browser fingerprints to boost the matching accuracy.

In some embodiments, when faced with low confidence matches, the platform engages the user in the decision-making process. Users can either affirm the lead's identity, thereby updating the existing profile, or distinguish the lead as related or entirely new, guiding the system in profile management. This collaborative decision-making augments data accuracy and personalizes the user's experience on the platform.

In some embodiments, each lead profile is uniquely identifiable and encompasses personal details and a log of their engagements. Once a lead is added, relevant platform users, based on their previous interactions and preferences, receive pertinent notifications. This real-time notification mechanism fosters a proactive engagement strategy for businesses, as they are constantly informed about leads' activities.

In some embodiments, only service providers who have interacted with a lead are privy to that lead's activity records and reviews. This ensures that sensitive information is shared judiciously, maintaining a balance between collaborative insights and lead privacy.

### BRIEF DESCRIPTION OF THE DRAWINGS

Various embodiments of the invention are disclosed in the following detailed description and accompanying drawings.

FIG. 1 illustrates a general flowchart of the lead engagement process within the platform, from the initiation of contact by a lead to the generation of notifications to service providers.

FIG. 2 represents a flowchart outlining the steps involved for a service provider to register and integrate with the platform, including the selection of the business industry, services, and profile creation.

FIG. 3A shows a first screenshot of a “My Leads” tab of the user dashboard, detailing the checklist of completed tasks, the list of leads, ratings, bid shopping instances, and options to add or import leads.

FIG. 3B highlights a “Company Info” tab of the dashboard, including the company details and a detailed selection of industry and services provided by the user.

FIG. 3C depicts a “Preferences” tab of the dashboard, where users can indicate when they would like to receive notifications concerning bid shopping, new reviews, and ratings of various types.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terminology used herein is for the purpose of describing particular embodiments only and is not intended to be limiting.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

### DESCRIPTION OF DRAWINGS

The present invention pertains to a unified platform designed for managing and monitoring engagements between service providers and potential leads. More particularly, the invention focuses on a technologically advanced system that aids in tracking and notifying service providers of leads' activities and engagements, especially in scenarios where leads have multiple engagements with various service providers within a similar classification of services. Such a system and platform not only streamline communication but also furnish service providers with pertinent information to optimize their client outreach and response strategies.

At the heart of the invention lies a central database, meticulously structured to store an array of data associated with both service provider profiles and lead profiles. The service provider profile data encompasses particulars regarding the services they offer and is categorized in a manner that promotes efficient querying and data retrieval. In parallel, the lead profiles are loaded with identifying data and a running record of their engagements with different service providers.

One or more servers, in operative connection with the central database, are programmed to receive lead engagement inputs from service providers. Upon receipt of such inputs, the servers execute a sequence of operations that include, but are not limited to, querying the database for matches, updating engagement records, and transmitting notifications to concerned parties.

The registration involves certain steps, ensuring that the data input is of the highest integrity and clarity. This process includes granting the platform access for automated data extraction from service providers' contact forms on their respective websites, enabling real-time or near-real-time tracking of lead engagements.

The platform incorporates mechanisms that deliver pertinent information to service providers without compromising on the leads' confidentiality. In scenarios where a lead interacts with multiple service providers of similar services, the invention's unique ability to discern and notify all involved parties of such engagements stands as a testament to its advanced design and utility.

Service providers, irrespective of their industry, can seamlessly integrate with the platform, gaining valuable insights into lead behavior and subsequently fine-tuning their client engagement strategies.

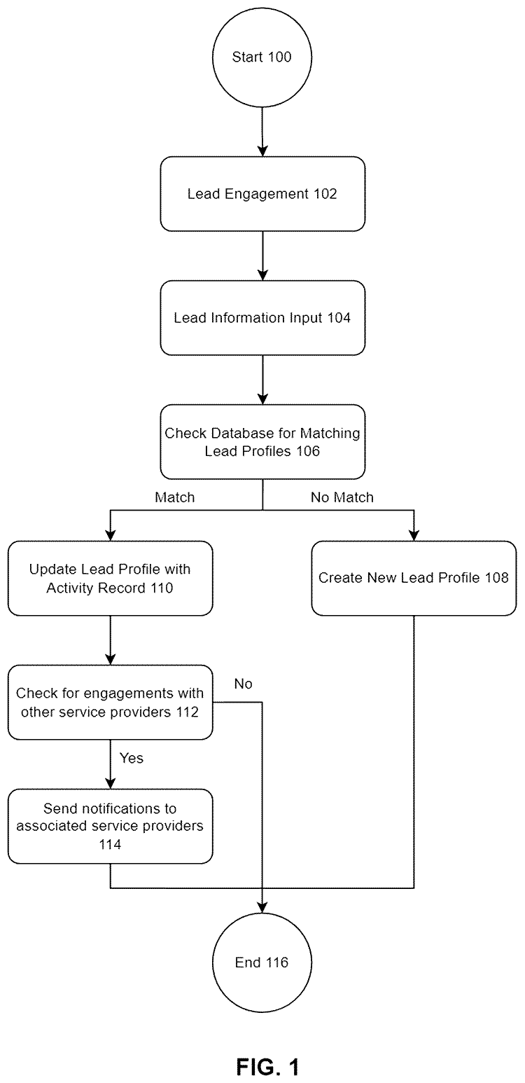

Referring to FIG. 1, an illustrative flowchart details the operational functionality of the platform, emphasizing the process flow from a lead's (client's) engagement with a service provider through to the generation of notifications.

After the start 100 the process begins with the lead engagement 102, where a lead either fills out a contact form or initiates a direct inquiry with a service provider.

The information is then directed forward to the system 104, either via a website contact form script or by manual entry from the service provider using the platform. At this step, all data acquired from the lead's engagement is channeled promptly to the platform.

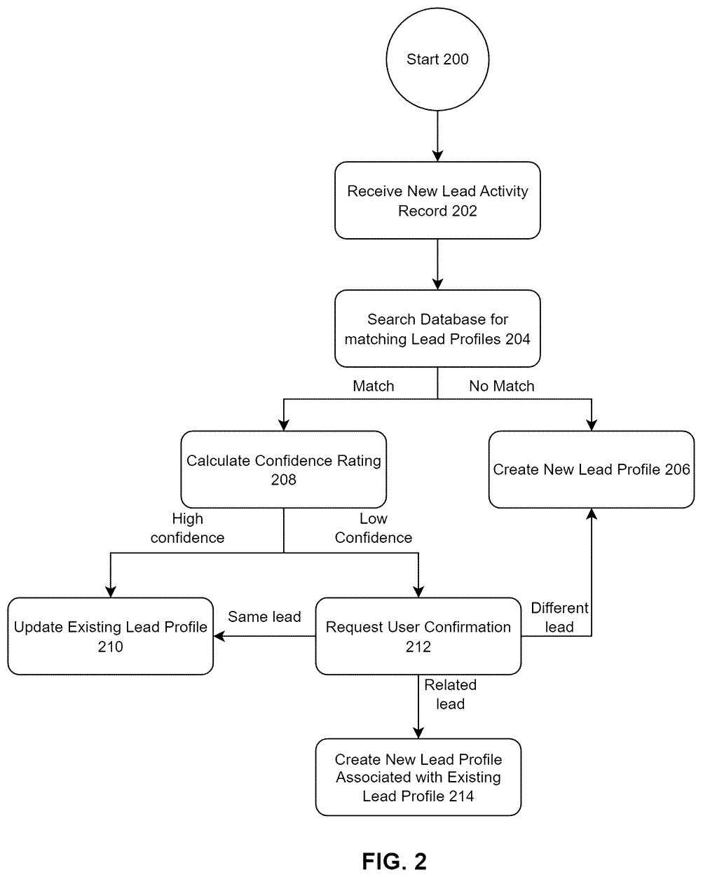

Next, the system checks database 106. The objective of this step is to discern if the data, especially the identifying particulars of the lead, matches any pre-existing profile within the database. This process is detailed more specifically in FIG. 2.

If no existing matching lead profile is identified, the process progresses to the create new lead profile 108. During this phase, a fresh lead profile, replete with the latest identifying data, is constructed within the database. The process would end here for a new lead.

Conversely, if a matching lead profile is detected, the system moves to update contact history 110. In this phase, the system logs the current engagement as a lead activity record alongside any prior interactions. The system then checks for multiple engagements 112. The platform conducts a thorough examination to ascertain if the lead has previously or concurrently engaged with other service providers who fall under an identical or analogous service category—i.e. whether they are bid shopping or not.

If the system identifies that the lead has had interactions with multiple service providers of the same category, it proceeds to the send notifications 114 step. This step involves the dispatch of notifications to all pertinent service providers registered on the platform, apprising them of the lead's engagement behaviors, thereby providing a competitive edge to service providers through enhanced market intelligence.

On the other hand, if no such multi-provider engagement is detected, the process moves directly to the end 116, concluding the platform's operations for that specific engagement instance.

FIG. 2 shows a flowchart describing the matching algorithm when a new lead activity record is input. The process begins with Start 200 and advances to the Receive New Lead Activity Record 202 stage, where details such as the name, address, phone number, email, IP address, and possibly a browser fingerprint of a lead are obtained. The system then proceeds to Search Existing Lead Profiles 204, in which existing lead profiles in the database are searched to identify matches based on the phone number or email of the lead.

If no match is found at step 204, the process advances to Create New Lead Profile 206, where the system creates a new lead profile unassociated with any existing lead profile. If a single match is found, the process proceeds to Calculate Confidence Rating 208, in which all existing lead profile information is compared with the new lead activity record's information. If confidence is high, the process advances to Update Existing Lead Profile 210, where the existing profile is updated with the new lead activity record information. If confidence is low, or if multiple matches are found at step 204, the system moves to User Confirmation Required 212.

At User Confirmation Required 212, the platform user is presented with the possible matching profiles and may confirm it is the same lead, specify that it is someone related to an existing lead, or specify that it is a different lead.

If the user confirms it is the same lead, the system proceeds to step 210, updating the existing lead profile with the new information. If the user confirms it is a new lead associated with the existing lead, the system creates a new lead profile and associates it with the existing lead profile 214. If the user confirms it is an entirely different lead, a new lead profile is created 206.

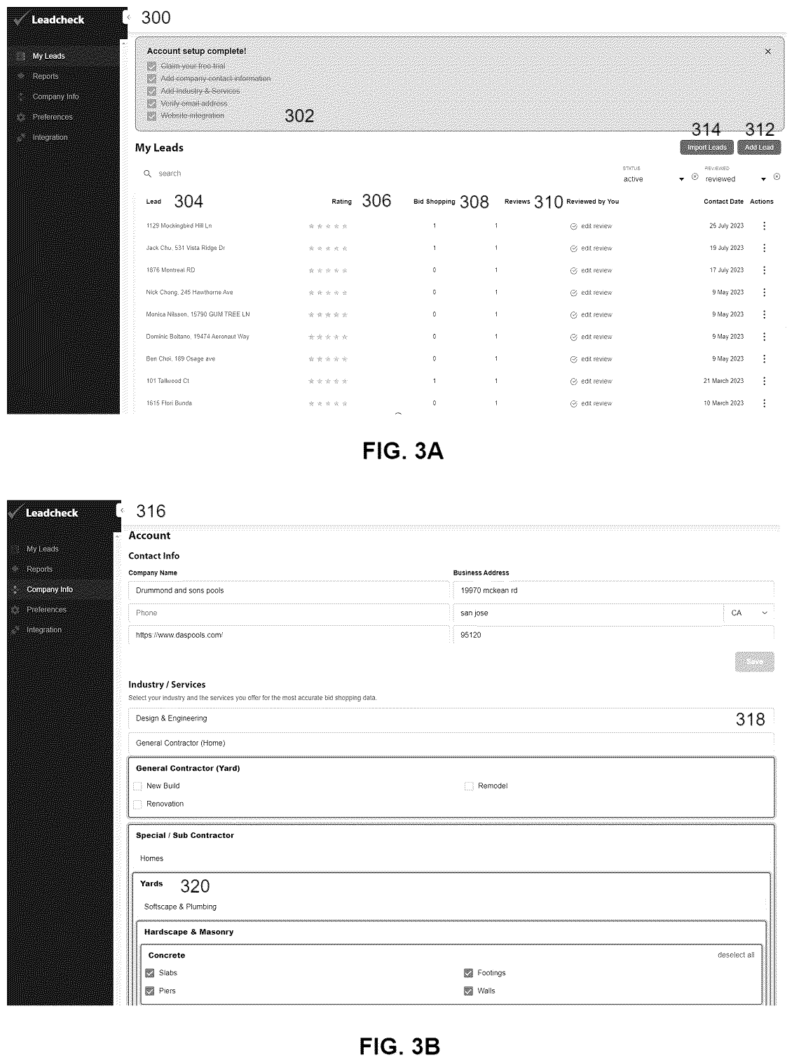

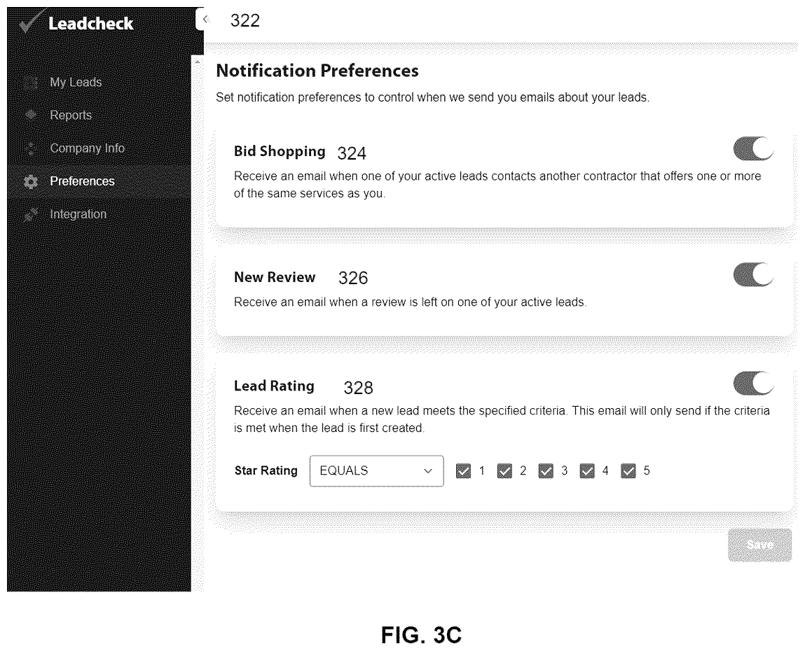

Referring to FIG. 3A, the user dashboard of the platform is presented, specifically focusing on the “My Leads” tab 300. Positioned at the upper region of this interface is a checklist 302, denoting tasks completed by the service provider. This checklist 302 confirms that the logged-in service provider has successfully added their company information, specified their industry and services, and incorporated their website contact form into the platform. Situated below this checklist 302 is a structured list 304 displaying leads added and reviewed by the service provider. Each lead entry in this list 304 carries distinct markers: the lead's name, its acquisition source, and the foremost line of the lead's address. These markers are followed by a star-based rating system 306, a counter representing tracked instances of bid shopping 308, and a count of the number of reviews 310 associated with each lead. Adjacently positioned above this list 304 are two action buttons: an “Add Lead” button 312 and an “Import Leads” button 314, with the latter facilitating the bulk importation of leads from text or CSV files.

Transitioning to FIG. 3B, the “Company Info” tab 316 of the user dashboard is depicted. Prominently displayed within this tab 316 are key details of the service provider, including the company name, contact data, physical address, and associated website URL. Positioned below these details is an area denoting the industry classification 318 chosen by the user—in this instance, “Design and Engineering”. Further granularity is achieved by the provision to specify services, illustrated here by the selection of “general contractor”. Nested within this broad service categorization are specific service checkboxes. For instance, under the “Yards” subsection 320, the service provider has chosen offerings such as the installation of concrete slabs, footings, walls, and piers.

Shifting attention to FIG. 3C, the “Preferences” tab 322 of the user dashboard is highlighted. This tab 322 grants users the autonomy to select their notification preferences. In the shown configuration, the user has elected to receive alerts on multiple fronts: notifications pertaining to bid shopping 324, alerts signaling the arrival of new reviews 326, and comprehensive notifications 328 covering all possible star ratings, ranging from 1 to 5 stars.

### Network Components

One or more of the operations and calculations described herein may be performed by a cloud infrastructure comprising one or more servers and databases. This is merely an example infrastructure however, the servers need not necessarily be cloud-based. The cloud infrastructure may for example comprise a database configured to receive and store multimedia content and user data for a plurality of user accounts and a set of connected servers or nodes configured to enact the operations as disclosed herein.

The cloud infrastructure is configured to communicate with a set of client devices by various means over the network architecture. The client devices include devices configured to communicate with the cloud infrastructure via a communications tower. These devices may include but are not limited to a smartphone, a laptop, and a tablet computer with e-mail and web browser application software.

Any one of the client devices may be operationally coupled to a wide area network (WAN) such as the Internet with a wireless connection. The wireless clients may be communicatively coupled to the WAN via a Wi-Fi (or Bluetooth) access point that is communicatively coupled to a modem, which is communicatively coupled to the WAN. The wireless clients may also be communicatively coupled to the WAN using a proprietary carrier network that includes communication tower.

While a specific set of client devices are listed as examples of the architecture, the client devices may in fact be any suitable device. For example, client devices could include a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

In some examples, each client device may be associated with or “logged in” to a service provider user profile or e-mail address in order to operate within the disclosed system and method, and further configured to send requests, upload user data, and generally interact with the cloud infrastructure via a user interface displayed on the device. Some operations may also be carried out automatically be installing software on certain webpages of the service provider.

In this manner one or more users may access an online platform or web page in order to interact with the system and methods of the present disclosure.

The operations described above for the app may be implemented by one or more servers or computers over a wireless network which the user device are communicating through. Indeed, it should be understood that the operations described herein may be carried out by any suitable processor architecture.

In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system for reviewing service provider experiences with clients have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A unified platform for managing and tracking engagements between service providers and leads, the platform comprising:
a database configured to store data associated with a plurality of service provider profiles and lead profiles, wherein data associated with each service provider profile includes a classification of services offered, wherein the data associated with each lead profile comprises identifying data and a record of engagements with service providers; and one or more servers operatively connected to the database, wherein the one or more servers are programmed to:
receive a lead engagement input from a first service provider, the engagement input including identifying data of the lead;
query the database to determine if the identifying data corresponds to an existing lead profile; if a match is detected, update the record of engagements for the lead profile to reflect interaction with the first service provider;
evaluate the record of engagements of the lead profile to discern whether the lead has previously interacted with other service providers sharing a similar classification of services with the first service provider; and
transmit a notification to both the first service provider and said other service providers, the notification incorporating select identifying data from the lead profile.

2. The platform of claim 1, wherein the transmitted notification to the first service provider and said other service providers further details the frequency of engagements the lead has undertaken with service providers sharing the same classification of services, as documented in the record of engagements.

3. The platform of claim 1, wherein the identifying data incorporated in the notification comprises a restricted amount of information, like one line of the lead's address, to preserve lead privacy.

4. The platform of claim 1, wherein the notification directed to the first service provider and said other service providers further encompasses a review history and cumulative rating associated with the lead profile.

5. The platform of claim 1, wherein to be incorporated into the system, each service provider undergoes a registration procedure that includes granting access to their website contact forms for automated data extraction.

6. The platform of claim 5, wherein the registration procedure further demands the service provider to select their business category from a predefined list, which consequently determines their service classification in the database.

7. The platform of claim 5, wherein the registration procedure additionally obligates the service provider to identify specific services they offer from a predetermined list, further refining their service classification in the database.

8. The platform of claim 1, wherein the lead's identifying data can comprise one or more of the following: a contact number, full name, or a primary line of address.

9. The platform of claim 1, wherein the one or more servers, to compare the received identifying data against stored data, employs hashing, generating a unique identifier for the received data and juxtaposing it against a collection of pre-existing unique identifiers.

10. The platform of claim 1, wherein the lead engagement input is autonomously transmitted to the platform when a lead interacts with a contact form on a service provider's website.

11. The platform of claim 1, wherein the notifications regarding the lead's record of engagements are dispatched to service providers through electronic mail.

12. The platform of claim 1, wherein the notifications detailing the lead's record of engagements are relayed to service providers via an online dashboard within the platform.

13. The platform of claim 1, wherein if the engagement input lacks essential identifying data, the one or more servers refrain from either querying or initiating a lead profile.
